(19) United States
(12) Patent Application Publication
(10) Pub. No.: US 2004/0047233 A1
(43) Pub. Date: Mar. 11, 2004

(54) Mixer

(76) Inventor: Thomas Ayrle, Obermeitingen (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/654,679

(22) Filed: Sep. 4, 2003

(30) Foreign Application Priority Data
Sep. 5, 2002 (DE) 102 40 997.8

(51) Int. Cl. B01F 5/08

(52) U.S. Cl. 366/336

(57) ABSTRACT

A mixer (1) for mixing at least two components from a foil pouch containing a first component and arranged in a housing and at least one second foil pouch arranged in the first foil pouch and containing a second component. The mixer (1) has an additional receiving space (7) on the threaded connector (4) for receiving a partially hardened two-component mass. The space is formed by an inner tube (6) arranged coaxial to the threaded connector (4), which extends from the threaded connector (4) up to the foil bag. At the time of replacing a used mixer (1) with a new mixer (1), the mass situated in the receiving space (7) is removed with the used mixer (1) and the remaining quantity of the first and second components present in the foil bag can be reused.

### BACKGROUND OF THE INVENTION

The invention relates to a mixer for mixing at least two components from a foil pouch arranged in a housing having a first component and at least one second foil pouch arranged in the first foil pouch having a second component, wherein the mixer has a threaded connector for connecting the mixer to a connection end of the housing.

High value chemical fastenings are produced from multi-component synthetic resin mortars. One component contains the reagent resin and the other component contains the hardener, whereby the two components are mixed in a mixer, for example a static mixer, to form the synthetic resin mortar [viz. epoxy resin]. Plastic cartridges having components arranged in parallel, foil cartridges with components arranged in parallel and a convergence part and plastic cartridges with coaxial arranged components are used as the container for multiple component synthetic resin mortars.

Foil cartridges are also known as a further type of container for two-component synthetic resin mortars, wherein a further foil pouch is formed in a foil pouch containing the first component and the second foil pouch contains the second component. These foil pouches can be expressed using single component expression devices and produce little waste after their use. Both components are reliably maintained and separated until their use. The connection between the foil pouch and the static mixer is created using a connecting part at whose one end the foil pouch is connected and at whose other end an external thread is arranged for connecting the static mixer. The container can be opened such that the sealing clip is stripped off due to the applied pressure or the foil pouch is cut off in front of the sealing clip. In the event of an interruption in the work process, the mass situated in the mixer hardens and the mixer is replaced by another mixer and the old foil pouch is replaced with a new foil pouch.

The drawback to the prior art solution is that the two components of the foil pouch can no longer be separated in the compounding part. The hardening reaction is triggered by virtue of the at least partial mixing of the components in the compounding part. In the case of an interruption in the work, the remaining contents of the container can no longer be used even if the mixer is changed, because the hardened portion of the mortar can no longer pass through the mixer and clog it.

### SUMMARY OF THE INVENTION

The object of the present invention is to provide a mixer in which a partially hardened mortar mass can be removed together with the mixer that is to be replaced. Said object is achieved by the features of claim 1. According to the invention, a mixer for mixing at least two components from a foil pouch containing a first component and arranged in a housing and at least one second foil pouch arranged in the first tube and containing a second component comprises a threaded connector for connection of the mixer to a connection end of the housing. An additional receiving space is provided at the threaded connector for receiving a partially or completely hardened two-component mass, wherein the receiving space extends from the threaded connector to the foil bag.

The entire contents of the foil bag can be used even in one or several work interruptions using the mixer according to the invention. Any partially mixed mortar mass hardens in the receiving space and is completely removed at the time of mixer replacement. The remaining contents of the foil pouch is available for further use after the new mixer is arranged on the threaded connector of the housing.

Preferably, the receiving space has an edge protruding from the threaded connector, which is a support edge for the foil bag for opening the foil bag. There must be a shoulder for the foil pouch that acts against the expression pressure if the sealing clip slips from the foil pouch due to the expression pressure of the expression device. This support shoulder can be the edge of the receiving space projecting from the threaded connector.

Preferably, the receiving space is formed by an inner tube arranged co-axially with the threaded connector. The separating distance of the intermediate space between the co-axially arranged inner tube and the inner wall of the threaded connector of the mixer is preferably selected to be of such a dimension that the walls of the connection end of the housing can penetrate into said intermediate space.

Preferably, the mixer is configured as a single-use type. The mortar mass situated in the mixer at the time of an interruption in the work hardens at least partially. The mixer is preferably manufactured out of a plastic and can be economically manufactured in mass production.

### BRIEF DESCRIPTION OF THE INVENTION

The exemplary embodiment of the invention will be more completely described below with reference to the drawings, wherein:

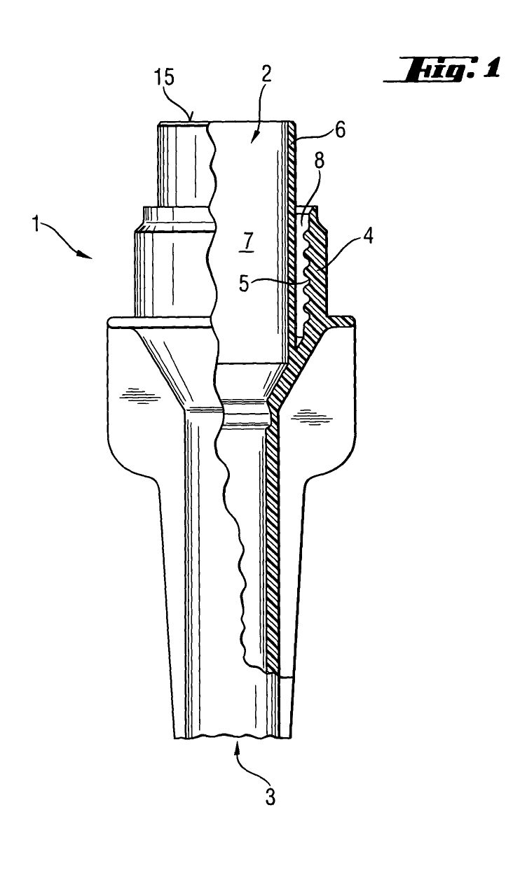

FIG. 1 shows a mixer according to the invention; and

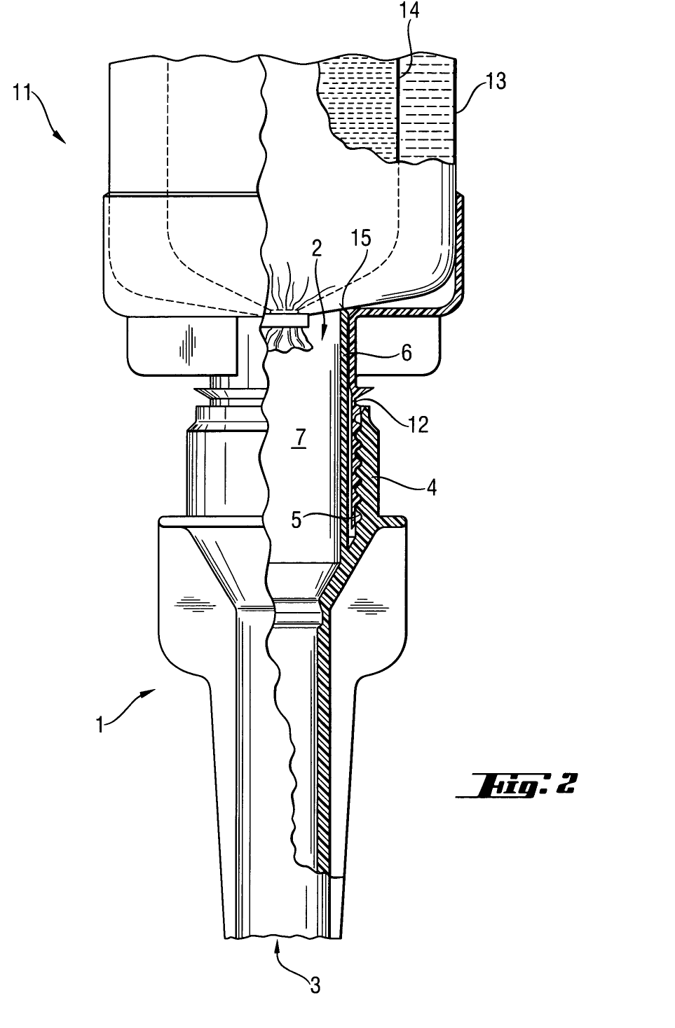

FIG. 2 shows a partial section of the mixer arranged on a housing.

### DETAILED DESCRIPTION OF THE INVENTION

In principle, in the drawings identical parts are identified using the same references.

FIG. 1 shows a partial cutaway of a mixer according to the invention. The mixer 1 has an entry opening 2 for infeeding two components of a synthetic resin mortar into the mixer and an outlet opening 3 out of which the synthetic resin mortar mixed in a static mixer is conducted to its utilization. The threaded connector 4 having a inner thread 5 for connection of the mixer 1 is arranged on a housing in the area of the entry opening 2. An inner tube is configured coaxial to the threaded connector 4, whereby the inner tube 6 extends beyond the threaded connector 4. An open space 8 is created between the external surface of the inner tube 6 and the inner surface of the threaded connector 4 for receiving a connecting piece of the housing. The receiving space 7 for receiving the partially hardened mortar mass is formed by the inner tube 6.

A partial cutaway of the mixer arranged on the housing is shown in FIG. 2. The mixer 1 is screwed onto the connector end 12 of the housing 11. The foil bag 13 containing the hardener as the first component of the synthetic resin mortar and an additional foil bag 14 arranged in the foil bag 14, which contains the reagent resin as the second component of the synthetic resin mortar, are arranged in the housing 11. The foil bags 13 and 14 are opened by prior opening of the foil bag 13 or 14 or by virtue of a pressure exerted upon the foil bag 13 or 14 by the expression device and the two components are fed through the receiving space 7 to the static mixer, upon maintaining the pressure, and are mixed. The mixed synthetic resin mortar is further fed via the exit opening 3 to its future utilization. The upper edge 15 of the inner tube 6 can be configured as a contact edge for the foil bag 14 or 14, which facilitates opening of the foil bag 13 or 14 by means of the expression pressure.

The two components already react in the area of the receiving space 7. In the event of an interruption in the work, the partially mixed mass already partially hardens in the receiving space 7. If the mixer 1 is removed from the housing 11 by unscrewing it, the partially hardened mortar mass in the receiving space 7 is also completely removed. After connection of a new mixer 1, the remaining quantity of the two components in the foil bags 13 and 14 can be further used.

In summary, it must be noted that using the mixer according to the invention, the completely hardened and the partially hardened mortar mass is removed with the mixer that is to be exchanged after an interruption in the work.

1. A mixer for mixing at least two components from a foil pouch (13) arranged in a housing (11) containing a first component and at least one second foil pouch (14) arranged in the first foil pouch and containing a second component; the mixer (1) comprises a threaded connector (4) for connecting the mixer (1) to a connector (12) of the housing (11), wherein an additional receiving space (7) for receiving a partially or completely hardened is arranged on the threaded connector (4), at least two-component mass is formed by an inner tube (6) arranged coaxial to the threaded connector (4), the inner tube (6) extends out of the threaded connector (4) up to the foil bag (13).

2. The mixer of claim 1, wherein the inner tube (6) has an edge projecting from the threaded connector (4) that is a contact edge (15) for the foil bag (13, 14) for opening the foil bag (13, 14).

3. The mixer of claim 1, wherein the mixer (1) is a disposable part.
